(19) United States
(12) Patent Application Publication
(10) Pub. No.: US 2010/0021155 A1
(43) Pub. Date: Jan. 28, 2010

(54) Flexible, positionable and grasping camera or other device mount apparatus

(76) Inventors: TOREN ORZECK, PORTLAND, OR (US); JOHN CHRISTOPHER BARKER, OCEANSIDE, OR (US)

Correspondence Address: STEVEN J. ADAMSON, PC, P.O. BOX 5997, PORTLAND, OR, 97228, US

(21) Appl. No.: 12/386,851

(22) Filed: Apr. 22, 2009

Related U.S. Application Data
(60) Provisional application No. 61/047,065, filed on Apr. 22, 2008.

(51) Int. Cl. G03B 17/00

(52) U.S. Cl. 396/428

(57) ABSTRACT

A camera or other items positioning device including a relatively hard endoskeleton substantially covered by a softer corpulent body. A mount region is coupled to the endoskeleton and configured to permit the releasable attachment of a camera or other device. The attachment mechanism may be mechanically or magnetically based, or both. The soft body permits the devices to be readily grasped by a user and to wrap securely about mounting structures of different size and shape. Several embodiments, including tripod, extra leg and monopod embodiments, are disclosed.

### CROSS REFERENCE TO RELATED APPLICATIONS

This application claims the benefit of U.S. Provisional Application No. 61/047,065, filed Apr. 22, 2008, entitled Optic Stabilization System and having Toren Orzeck as an inventor.

### FIELD OF THE INVENTION

The present invention relates to devices on which a camera or other optical device may be mounted and positioned.

### BACKGROUND OF THE INVENTION

Various tripod devices are known on to which a camera or spotting scope may be mounted. These tripod devices typically provide various positioning features which may include height adjustment, pan and tilt, and universal ball and socket movement. These features are typically achieved through releasably locking mechanisms that provide mount pivoting or telescoping vertical movement and the like.

These tripod devices are disadvantageous in that they tend to be bulky, expensive, rigid (which may damage a lens or camera body when stored together), and are prone to ready failure went bent or otherwise damaged in the field.

Other devices are known to which a camera or other optical device may be mounted. These include a product known commercially as the Gorillapod that consists of three bendable legs that extend from a mount unit. The legs are formed of a series of interconnected ball and socket members formed of hard plastic. A thin rubber ring is provided about each of the socket housings.

This product is disadvantageous in that it does not adequately support larger cameras, the hard material of their exposed structural skeleton can damage a camera with which it is transported and used, and it presents a rather hard and size-limited exterior contact surface, for grabbing and friction-based mounting. Also, the device is not very well anchored or stabilized.

### SUMMARY OF THE INVENTION

Accordingly, it is an object of the present invention to provide a camera or other device positioning apparatus that overcomes the disadvantageous features of the prior art.

It is another object of the present invention to provide a camera or other device positioning apparatus that has a soft, compliant body that affords protection to a camera or other device, enhanced surface area for friction-based mounting and/or a comfortable substrate into which the hand of a user can secure grab.

It is also an object of the present invention to provide a camera or other device positioning apparatus that magnetic based mounting of an ancillary article, a cord for increased stability and anchoring and/or enhanced flotation.

These and related objects of the present invention are achieved by use of a flexible, positionable and grasping ancillary article mount apparatus as described herein.

The attainment of the foregoing and related advantages and features of the invention should be more readily-apparent to those skilled in the art, after review of the following more detailed description of the invention taken together with the drawings.

### DETAILED DESCRIPTION

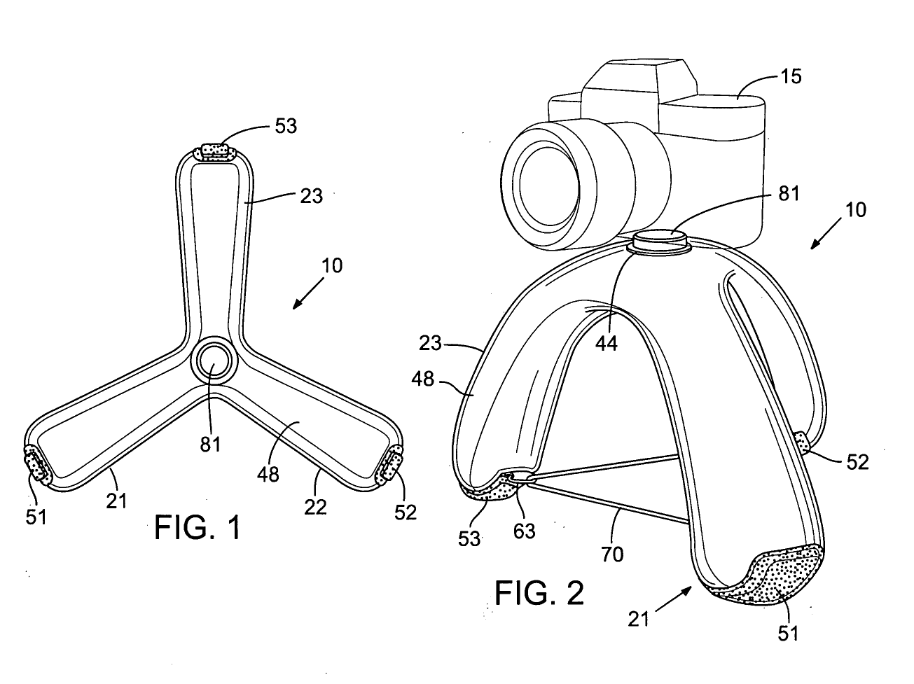

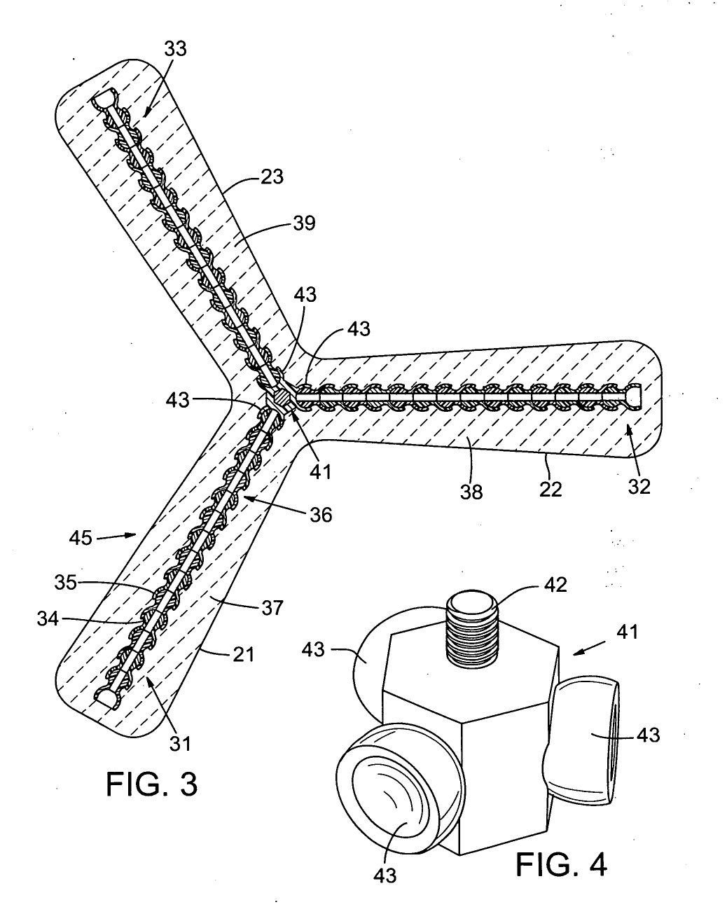

Referring to FIG. 1, a top plan view of a positioning device 10 to which a camera 15 or other ancillary article may be mounted in shown in a “flattened” position. Referring to FIG. 2, a perspective view of device 10 in a “dome” positioned is shown. Referring to FIG. 3, a cross-sectional view (in the horizontal plane) of device 10 as disposed in FIG. 1 is shown (with the feet excluded). Referring to FIG. 4, a perspective view of a mount base 41, into which the leg supports 31-33 of legs 21-23 couple in accordance with the present invention is shown. The term ancillary article will be used herein to refer to a camera, spotting scope, light, sensor or any other device that can be mounted to the positioning devices of the present invention.

Device 10 may include three legs 21-23 that are joined at a center region 40 that includes mount base 41. Each leg preferably includes an endoskeleton or support section 31-33. The endoskeleton is preferably configured such that a user may bend a leg into a desired position and the leg will retain the shape to which it is bent.

In the embodiment of FIG. 3, each leg endoskeleton section 31-33 is configured from a series of interlocking ball and socket members 36. These members are formed with an inherent shape and bias that permits the ball 34 of one member to move under force in the socket 35 of an adjacent member and then retain the new alignment when the bending force is withdrawn. Ball and socket arrangements of this type are known in the art.

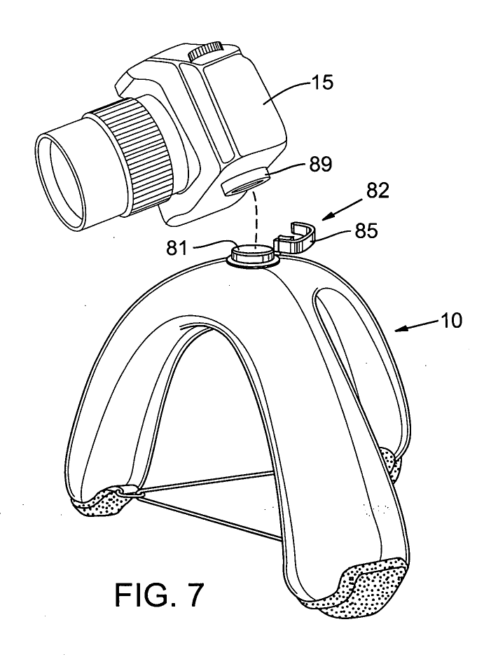

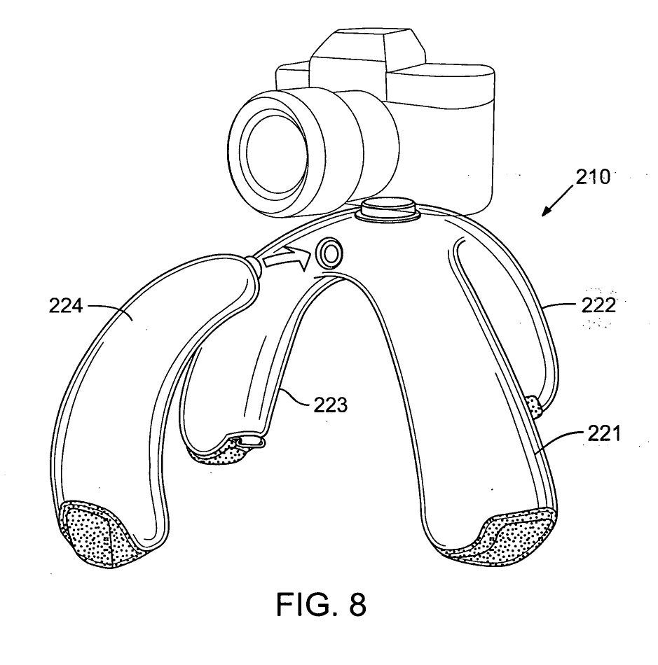

The mount base 41 may have a mount structure on one side (preferably the top) which may be a threaded member 42 such as that found on a tripod or other camera or optical device mounting mechanism. A magnetic based mounting system (discussed in more detail with reference to FIGS. 7 and 8 below) may be coupled to threaded member 42 or another mount structure. In FIGS. 1 and 2, a magnet 81 is provided at mount base 41 for the releasable magnetic attachment of a camera or other ancillary article. FIGS. 1 and 2 also illustrate the use of a platform 44 (through which threaded member 42 preferably extends to mount to the underside of the housing magnet 81). Platform 44 distributes weight and protects the body 45 and skin 48 adjacent the mount area.

The mount base 41 preferably has a plurality of sockets 43, or another suitable arrangement, for coupling to each of the endoskeleton legs.

Through movement of the leg supports 31-33, device 10 can be repositioned from a flat shape shown in FIG. 1 to a dome shape shown in FIG. 2, or various other positions, including wrapping the legs around an object, e.g., a post, tree, frame, or other structure that may provide an advantageous perch for a camera, optical device or other item.

The endoskeleton is preferably housed in a body of a soft, formable material that has shape memory. Small cell, soft foam is one suitable material, though other materials may be used. The soft, corpulent foam body provides several advantageous features which include, but are not limited to the following. The foam body renders device 10 easy to grasp and hold by a user. It is soft on the hand, and fingers readily compress into and hold the device. The compressible foam body combined with the bendable legs creates a device that may be wrapped around a camera and lens (or other object) to protect that item during transport. Furthermore, the broader foam body provides greater surface area for branding or use information and pockets or other attachments for gear, etc. Furthermore, the broad body provides ample surface area for friction-based retention of device 10 in a desired position, for example, when wrapped around a tree or other item.

The compressible foam body is referred to as a whole by reference numeral 45 and in the individual legs 31-33 by reference numbers 37-39, respectively.

The exterior of the compressible body may be cloaked in a skin 48. Attributes of the skin include protection of the compressible body 45, increased friction for mounting to a support structure, improved tactile sensation in the hand of a user, and increased branding and design features. The skin may be one or more of neoprene, nylon, formed integrally as a hardened skin of the foam of body 45 or of another suitable material. In one embodiment, the interior/bottom side skin may be neoprene for increased friction and the exterior/top skin may be a stretchable nylon providing a smooth feel to a user.

The skin may also be formed integrally with the foam or other material of the compressible body. This permits fabrication of feet in the same molding process, formation of additional traction/friction elements, and formation of ribs or the like to enhance gripability, etc.

As shown in FIG. 1, each leg 31-33 preferably has a foot 51-53, respectively, and a cord connecting structure 61-63, respectively, which may be a D-ring or other suitable structure. The feet may be made of a non-slip rubber or other material and may provide the benefits of non-slip gripping to a surface and protection for the ends of the legs.

A cord or cable 70 may be run through the D-rings to stabilize the legs (for example, as shown in FIG. 2), increase the load capacity of the device, and securely attach the device to various mounting structures (tree, pole, frame, etc.). It should be recognized that as an alternative to the D-ring, an eyelet or other suitable opening for cord 70 may be formed directly in feet 51-53.

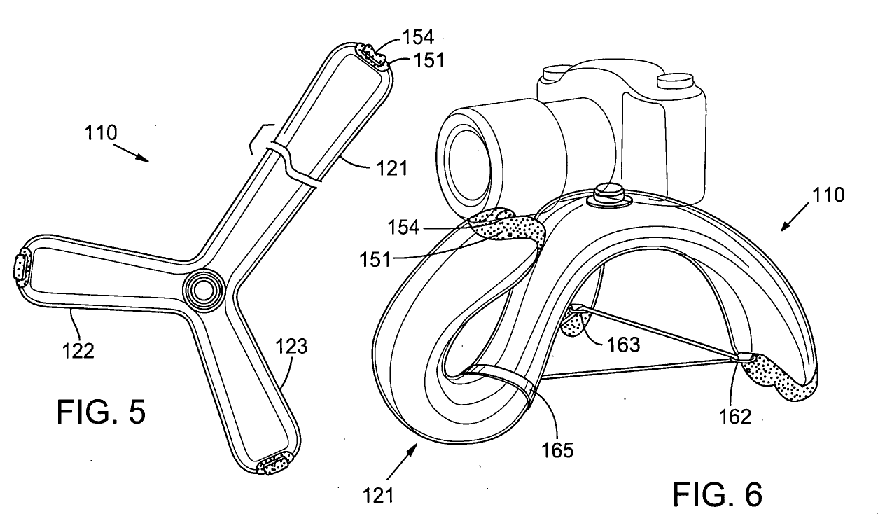

Referring to FIGS. 5-6, a top plan view in a “flattened position” and a perspective view in a “domed position” of another embodiment of a positioning device 110 in accordance with the present invention are respectively shown. Device 110 is similar to device 10 of FIG. 1 and preferably has the same or substantially similar endoskeleton structure and corpulent body.

Device 110 has at least one leg 121 that is longer than the other two. As shown in FIG. 6, this leg may be folded backwards and used to support a longer lens (and provide more even weight distribution when a longer lens is used). Foot 151 at the end of legs 121 may have a recess 154 formed therein to receive a lens. During transport this longer leg may be positioned under and then folded backwards over a lens to provide cushioned protection about the lens.

A band or other base 165 (position adjustable or not) may be provided on the longer leg 121. It is preferably position at a similar distance from mount base 141 as the cord connecting structures 162,163 and anchors a cord connecting structure 161 (on the interior side of leg 121). It is obscured from view in FIG. 6 by leg 121.

Referring to FIG. 7, one embodiment of a magnetic mount assembly is shown. This assembly includes magnet 81 and a pivoting snap fit clip 85 that may be snapped into a releasable locking position about the magnet and the adapter mounted on the bottom of the ancillary article. This assembly provides both magnetic and mechanical releasable attachment.

Referring to FIG. 8, a perspective view of another embodiment of a positioning device 210 in accordance with the present invention is shown. Device 210 is similar to that of device 10 yet includes the additional feature of a detachable leg. For example, device 210 may be similar to device 10, yet permit the addition of a longer leg when one is desired to support or protect a longer lens, or when additional support is needed for the mount base 241.

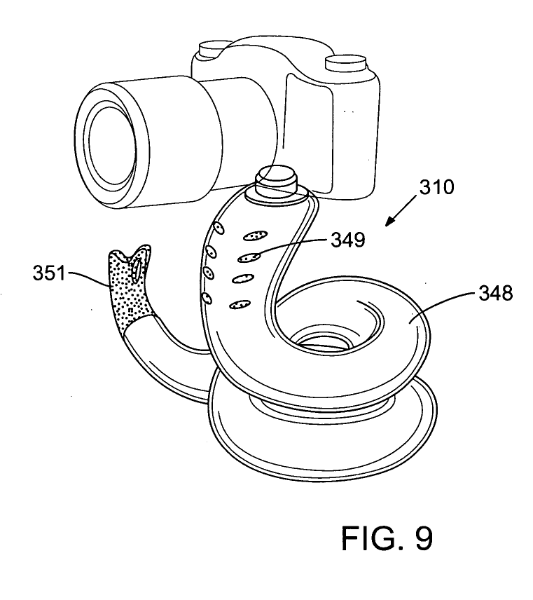

Referring to FIG. 9, a perspective view of another embodiment of a positioning device 310 in accordance with the present invention is shown. Device 310 is similar to devices 10,110,210 in that it has an endoskeleton covered by a compressible body and is similarly positionable. Device 310 is substantially linear or serpentine in shape compared to the three legged embodiments of devices 10,110.

It should be recognized that while the leg endoskeletons are shown as serially arranged ball and socket members (which may be made of plastic, metal, fiberglass or other materials), the endoskeleton sections may be formed of bundles of metal wire or as individual bendable metal members or of other suitable bendable and positionable materials.

At one or more foot regions or along one or more legs, an accessory socket may be provided for the attachment of accessories such as flashes and longer legs, etc.

The body may include memory foam or non-memory foam depending on desired characteristics. Alternative materials include fibrous materials or other suitable compressible, resilient materials.

The skin may be formed of cloth, neoprene, nylon, a second layer of foam, or a combination of these or other materials.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A camera or other item positioning device, comprising:
a mount base;
at least three legs that coupled to and extend from the mount base, wherein each leg includes a leg endoskeleton section that is bendable by the hand of a user and substantially retains the position to which it is bent; and
at least three continuous bodies of soft compressible material, one each substantially surrounding one of the leg endoskeleton sections along at least half of its length.

2. The device of claim 1, further comprising at least three foot members each formed of a material that is harder than the soft compressive material, one each coupled to the legs at an end opposite the mount base.

3. The device of claim 1, wherein the mount base includes an ancillary article attachment structure for the releaseable attachment of an ancillary article to the mount base.

4. The device of claim 3, wherein the attachment structure includes at least one of a threaded protrusion and magnetically active material.

5. The device of claim 2, wherein at least one foot member has a recess between to outwardly disposed protrusions.

6. The device of claim 1, wherein the compressible material of the body has shape memory.

7. The device of claim 1, wherein each of the continuous bodies extends substantially the entire length of its corresponding endoskeleton section.

8. The device of claim 1, further comprising at the mount base a releasable mechanical fastener that includes a pivot mounted clip for mounting an ancillary article.

9. The device of claim 3, wherein the ancillary article attachment structure includes magnetic-based releasable attachment and an anti-rotation mechanism to impede rotation of an ancillary article that is magnetically coupled to the mount base.

10. The device of claim 1, wherein one of the at least three legs is longer than the other two legs.

11. The device of claim 1, wherein one of the at least three legs is detachable.

12. The device of claim 1, further comprising a skin encasing at least one of the continuous bodies, the skin having an outwardly disposed section of a first material and an inwardly disposed section of a second material that is different from the first material.

13. The device of claim 1, further comprising a skin encasing each of the continuous bodies, wherein the skin is formed integrally with the body of the same material, yet more dense.

14. The device of claim 1, wherein each leg includes an attachment member through which a stabilizing cord may pass.

15. A camera or other item positioning device, comprising:
a mount base;
at least three legs that coupled to and extend from the mount base, wherein each leg is comprised of a plurality of interconnected leg members that are moveable with respect to one another and configured such that when moved to a given position, the plurality of interconnected leg member substantially retain that position; and
at least three continuous bodies of soft compressible material, each substantially surrounding two or more of the plurality of interconnected leg members of that leg along their length.

16. The device of claim 15, wherein the mount base includes an ancillary article attachment structure for the releaseable attachment of an ancillary article to the mount base, and the attachment structure includes at least one of a threaded protrusion and magnetically active material.

17. The device of claim 1, wherein each of the continuous bodies extends substantially the entire length of its corresponding endoskeleton section.

18. The device of claim 1, wherein the compressible material of the body has shape memory.

19. The device of claim 1, further comprising at the mount base a releasable mechanical fastener that includes a pivot mounted clip for mounting an ancillary article.

20. A camera or other item positioning device, comprising:
a mount base including an ancillary article attachment structure for the releaseable attachment of an ancillary article to the mount base;
at least one leg coupled to and extend from the mount base, the leg comprised of a plurality of interconnected leg members that are movable with respect to one another and configured such that when moved to a given position, the plurality of interconnected leg member substantially retain that new position; and
a substantially continuous body of soft compressible material that substantially surrounds three or more of the plurality of interconnected leg members along their length.
